(19) United States
(12) Patent Application Publication
(10) Pub. No.: US 2008/0047185 A1
(43) Pub. Date: Feb. 28, 2008

(54) Label

(76) Inventor: Roland Schreiner, Munich (DE)

Correspondence Address: NIXON PEABODY, LLP, 401 9TH STREET, NW, SUITE 900, WASHINGTON, DC, 20004-2128, US

(21) Appl. No.: 11/632,216

(22) PCT Filed: Jun. 9, 2005
(86) PCT No.: PCT/EP05/52664

§ 371 Date: Aug. 30, 2007

(30) Foreign Application Priority Data
Jul. 20, 2004 (DE) 10 2004 035 045.0

(51) Int. Cl. G09F 3/10

(52) U.S. Cl. 40/630

(57) ABSTRACT

The invention relates to a label comprising a tab (2). The inventive label is characterized in that in the area of the tab (2) the adhesive coating (3) is imprinted with an intumescence coating, i.e., a layer (4) from a foamable material, thereby reversing the adhesive effect of the adhesive coating (3) on the support (5) in the area of the tab (2). In principle, the foamable. layer (4) does not necessarily have to be provided on the adhesive coating (3). It can also be provided directly on the bottom face of the plastic film layer (1). The layer (4) serving as the intumescent means is activated by heating it. Once the layer (4) has been activated, the area of the tab (2) is prominent to such an extent that it can be easily gripped in order to peel of the label from the support (4). Since the layer (4) cannot freely expand in the area adjoining the adhesive layer (3), this area is arched, i.e., the tab (2) stands out above the edge of the support (5), thereby making it easier to lift it off.

The present invention relates to a label, particularly a label which has a grip tab.

Grip tabs are areas situated on edge of labels or removable label parts, which do not adhere or only adhere with reduced adhesive force on the bottom to the intended substrate of the label or label part. They may either project out of the label contour, or they may be implemented as corner or edge areas incorporated without a transition into the remaining label contour. As the term already implies, labels stuck onto a substrate may be grasped more easily at a grip tab than at label edges which are not accordingly pronounced.

Grip tabs are typically used for the purpose of making it easier to remove the label or label parts which are attached using adhesive to a substrate. In particular in the pharmaceutical field, containers (such as injection ampoules, pharmaceutical doses, etc.) are frequently equipped with removable labels or label parts, which are pulled off after application of the pharmaceutical located in the container and stuck into the patient file, a laboratory notebook, or the like. Voucher sections which may be pulled off separately from the remaining label using grip tabs are known for the medical field, for example, from EP 0 463 193 A1.

In addition, removable labels or label parts having grip tabs are also provided in other areas where the particular label or the particular label part only fulfills a temporary function and would impair the visual appearance after fulfilling this function. Examples are lacquering protection and price labeling, in particular of gift articles.

Occasionally, however, grip tabs may also be provided for other purposes, for example, to grip the entire object provided with the label at the grip tab.

There are various possibilities for technically implementing grip tabs. Firstly, the area of a grip tab may be left out when coating the label bottom with pressure-sensitive adhesive. However, this frequently may not be implemented in practice, since labels are typically stamped out of continuously self-adhesive coated web material. Therefore, the initially self-adhesive area of the grip tab is usually printed over with an adhesive killer, using which the adhesive effect is largely canceled out. Furthermore, the initially self-adhesive area of the grip tab may have a non-adhesive film part dispensed under it, or the removal material on which self-adhesive labels are typically situated is stamped out in the area of the grip tab, so that it remains there during dispensing onto the label. The latter variation is known from DE 197 50 479 A1.

While typical labels having a grip tab to allow the user to grip the correspondingly equipped label without having to previously scrape it carefully off of the substrate from the edge using the fingernails or even a tool, there are still restrictions in the use.

Thus, it is often difficult in particular to grip typical grip tabs using gloves, such as surgical or laboratory gloves,. However, delays caused by handling problems are highly problematic in certain circumstances precisely in medical use, even if they are only in the range of a few seconds. Even if no significant delay exists, it may already have a negative effect if removing a label or a voucher section requires too much attentiveness, instead of being able to perform this casually, possibly without even looking at it.

In consideration of these problems, it is the object of the present invention to provide a label which may be gripped more easily, in particular also for wearers of gloves, than typical labels having a grip tab.

This object is achieved according to one aspect of the present invention by a label according to Claim 1.

Advantageous embodiments of the present invention may be implemented according to one of Claims 2 through 8.

Because the intumescence means cause the grip tab, possibly after activation of the intumescence means, to project above the surface of the remaining label, it may be gripped significantly more easily than typical grip tabs. Furthermore, the grip tab may thus also be found rapidly in purely haptic ways, i.e., “blind”, without further measures.

If the intumescence means are activatable, for example, foamable, activation may be performed before or after the dispensing of the label depending on application. Furthermore, it may be advantageous in many cases to first activate the intumescence means later, possibly directly before the removal of the label.

Intumescence means changeable in the thickness may not only be implemented in the form of activatable agents, but rather the technical achievement of the object according to present invention may also be implemented in other ways, for example, in the form of a foam piece, which is attached to the label on the bottom in the area of the grip tab.

The application of a foam layer on the bottom may be performed by dispensing from below, for example. Furthermore, it is also possible to first produce a web-shaped: composite of a self-adhesive coated film web, foam, and a carrier web, which has an adhesive-repellent surface, in such a way that the foam comes to rest in a repeating pattern over part of the area between the adhesive-repellent surface of the carrier web and the self-adhesive coating of the film web, and then stamp the contours of the labels to be produced through the film web in such a way that each label contour encloses film material and foam in the area of the grip tab and otherwise only encloses film material.

The web-shaped film composite may be produced by first stamping out empty contours from a foam web, and then laminating the foam web together with the film web and the carrier web in such a way that the foam web comes to rest between the adhesive-repellent surface of the carrier web and the self-adhesive coating of the film web. The contours of the label are then stamped in such a way that the label contours intersect with the empty contours.

Alternatively, the web-shaped film composite may be produced by first dispensing foam pieces onto the self-adhesive coating of the film web and laminating the film web together with the carrier web in such a way that the foam pieces come to rest between the adhesive-repellent surface of the carrier web and the self-adhesive coating of the film web.

Alternatively, the web-shaped film composite is producible by providing the carrier web with foam pieces which adhere to the adhesive-repellent surface of the carrier web using a self-adhesive coating over part of the area, and laminating over the self-adhesive coated film web in such a way that the foam pieces come to rest between the adhesive-repellent surface of the carrier web and the self-adhesive coating of the film web. The label contours are then stamped through the film pieces in such a way that the self-adhesive coating of the foam pieces lies outside the label contour in each case.

In principle, any variation of the present invention described and/or indicated in the scope of the present application may be especially advantageous, depending on the economic and technical conditions in the specific case.

If labels according to the present invention having intumescence means are provided in the form of foam pieces on a carrier web having an adhesive-repellent surface which is rolled up, the foam pieces are first compressed by the web as a result of it being rolled up. Upon unrolling, they may expand again because of their intrinsic elasticity.

The effect according to the present invention of the intumescence of the grip tab functions especially well on curved substrates, for example, round containers, as are often typical precisely in pharmaceutical applications.

In the following, examples of preferred embodiments of the present invention are explained in greater detail on the basis of the attached drawing. The figures of the drawing are purely schematic illustrations, which are not to scale, in particular, in sectional illustrations, layer thicknesses are greatly enlarged for reasons of visibility. Elements corresponding to one another are each provided with the same reference numerals in the individual figures.

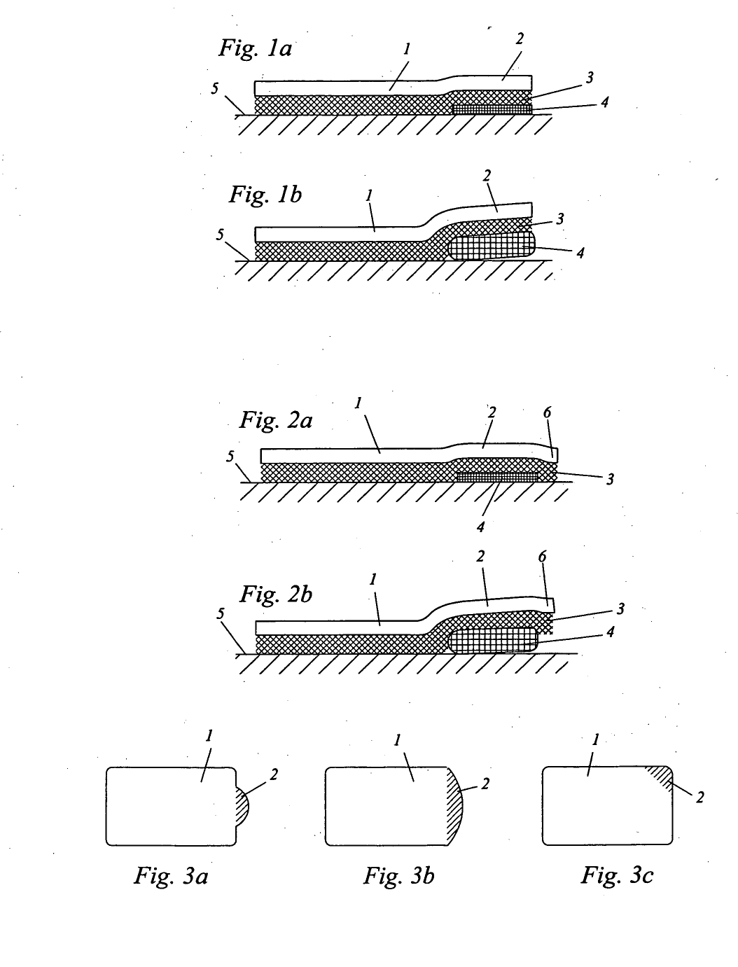

FIG. 1a shows a section through a label according to the present invention before activation of the intumescence means, which are implemented as an intumescence ink layer.

FIG. 1b shows a sectional illustration of the label from FIG. 1a, but after activation of the intumescence means.

FIG. 2a shows a section through a further label according to the present invention before activation of the intumescence means, which are implemented as an intumescence ink layer here.

FIG. 2b shows a sectional illustration of the label from FIG. 2a, but after activation of the intumescence means.

FIGS. 3a-c show top views of three different variations of the incorporation of the grip tab according to the present invention into the label contour.

The label illustrated in FIG. 1a has a plastic film layer 1 having a pressure-sensitive adhesive coating 3. Depending on the intended use, greatly varying plastics and pressure-sensitive adhesives, which are also used for typical labels, may be employed. Multilayer embodiments may also be expedient. In principle, the design according to the present invention of the grip tab 2 is combinable with nearly all known film structures of labels, including void films and other special labels.

In the area of the grip tab 2, the pressure-sensitive coating 3 is printed over with intumescence ink, i.e., a layer 4 made of foamable material. Intumescence inks are commercially available under the English name “puff ink”. Furthermore, additives are offered by various producers under the names “puff additive” or “puffing agent”, which may be added to typical (particularly screen) printing inks in order to make them foamable, i.e., to make them into intumescence inks in the meaning of the present invention. It is not necessary for the foamable layer 4 to be colored for its function, if a transparent plastic film layer 1 is used, however, the coloration of the foamable layer 4 may make the visual localization of the grip tab easier. Otherwise, the layer 4 is also producible from the binders of typical printing inks, for example, to which a “puffing agent”, but no pigment, is added.

The adhesive effect of the pressure-sensitive adhesives coating 3 on the substrate 5 is canceled out in the area of the grip tab 2 by the printing over using the intumescence layer 4. In principle, the foamable layer 4 does not necessarily have to be situated on the pressure-sensitive adhesive coating 3, however. Situating it directly on the bottom of the plastic film layer 1 is also possible.

The layer 4 used as the intumescence means is activated by heating. This may be performed using an infrared radiator or a heated stamp, for example.

FIG. 1b shows the label from FIG. 1a after thermal activation of the layer 4, which is now in the foamed state 4. The area of the grip tab 2 is now strongly raised, so that it may be gripped easily in order to remove the label from the substrate 5. Because the layer 4 may not expand arbitrarily where it adjoins the pressure-sensitive adhesive layer 3, in addition, there is arching, i.e., the grip tab 2 lifts off of the edge of the substrate 5, so that it is easier to grip underneath it.

FIGS. 2a and 2b show an embodiment of the present invention largely corresponding to FIGS. 1a and 1b. In contrast to the above exemplary embodiment, however, the edge area 6 of the grip tab, which is coated with pressure-sensitive adhesive, projects somewhat above the foamable layer 4. Before the activation of the layer 4, the grip tab 2 is thus fixed via the pressure-sensitive adhesive layer 3 on the substrate 5 (FIG. 2a). A design of this type may have certain advantages during automatic dispensing, in particular if the grip tab 2 is relatively large.

The edge area 6 is pulled off of the substrate 5 by the foaming of the layer 4, as shown in FIG. 2b, so that the grip tab 2 may be gripped easily.

FIGS. 3a through 3c show various possibilities of the integration of a grip tab 2 according to the present invention into the label contour. None of these involve a complete intumescence, of course. The grip tab 2 may be implemented as a bulge of the contour of the label (FIG. 3a), or a larger edge area (FIG. 3b), or a corner area (FIG. 3c) of the label.

Simple basic shapes, which may be altered strongly, of course, are merely shown in FIGS. 3a-c. Therefore, imprints or other inscriptions which labels according to the present invention are normally provided with are not shown. Equipment features such as punch-outs, holograms, label booklets, etc., which are known per se in the field of label technology and may be provided in connection with the present invention, are also not shown.

1. A label, which has a grip tab wherein intumescence means, which are changeable in thickness, are provided in an area of the grip tab, and the grip tab is raisable using the intumescence means.

2. The label according to claim 1, which is self-adhesive.

3. The label according to claim 2, wherein the area of the grip tab is non-adhesive or has its adhesive force reduced in comparison to the rest of the label.

4. The label according to claim 1, wherein the intumescence means are activatable.

5. The label according to claim 4, wherein the intumescence means are thermally activatable.

6. The label according to claim 4, wherein the activation of the intumescence means is a foaming procedure.

7. The label according to claim 6, wherein the intumescence means comprise an intumescence ink layer.

8. The label according to claim 1, wherein the intumescence means comprise a foam. 10251705.1
